(19) United States
(12) Patent Application Publication
(10) Pub. No.: US 2019/0328607 A1
(43) Pub. Date: Oct. 31, 2019

(54) ANIMAL SELF-MASSAGE DEVICE

(71) Applicant: Neal E. Weisman, Philadelphia, PA (US)

(72) Inventor: Neal E. Weisman, Philadelphia, PA (US)

(21) Appl. No.: 15/963,378

(22) Filed: Apr. 26, 2018

(51) Int. Cl. A61H 15/00; A01K 13/00; A61D 99/00

(52) U.S. Cl. CPC A61H 15/00; A01K 13/00; A61H 2201/1673; A61H 2015/0014; A61H 2201/1652; A61D 99/00

(57) ABSTRACT

A massage device either for an animal's stomach or back general area utilizes rotating rollers. The massage device includes pads to comfortably absorb some of the animal's force on the device along with straps to hold the device around the animals back or stomach.

### FIELD OF THE INVENTION

The invention relates to the field of devices for enhancing animal well-being and health through tactile stimulation.

### BACKGROUND

The benefits of massage therapy for animals have been recognized by animal owners and veterinarians. To this end, devices for providing massage therapy to animals have been proposed in the prior art. An example of such a device can be seen in United States Patent Application Publication No. US2008/0022943 A1, published on Jan. 31, 2008, and naming Martha S. Jones as inventor (hereinafter “Jones”). Jones shows a glove for massaging an animal that incorporates electrically powered vibrators. Such devices need to be located near a power supply or produce environmentally objectionable waste in the form of used batteries. Also, the availability of the massage is limited by the availability of a human attendant.

### SUMMARY OF THE INVENTION

The present invention is directed to a massage device for an animal that includes a frame supporting rotating massage elements, for example rollers, and a strap system for holding the frame about the animal's body. The massage device also includes pads to comfortably absorb some of the force that the animal may exert on the device. In some embodiments, the massaging action of the massaging elements is powered by the movements of the animal and can be made available to the animal without the need for a human attendant.

Accordingly, it is an aspect of the present invention to provide a massage device for an animal, the animal having a body, the massaging device comprising:

a support structure;

a strap system for holding the support structure about the body of the animal; and

a plurality of massaging elements supported by the support structure,

wherein the strap system is configured to allow the support structure to assume a position in close enough proximity to the body of the animal such that motion of the massaging elements administers a massage to the animal or provides a massaging action to the animal.

It is another aspect of the present invention to provide a massaging device in accordance with one or more aspects of the present invention described herein, wherein the support structure is a frame supporting the massaging elements for rotational motion, and wherein the massaging elements are configured for rotational motion while administering the massage to the animal.

It is yet another aspect of the present invention to provide a massaging device in accordance with one or more aspects of the present invention described herein, wherein the massaging elements are rollers supported for rotational motion relative to the frame.

It is yet another aspect of the present invention to provide a massaging device in accordance with one or more aspects of the present invention described herein, wherein the frame is a rectangular frame including at least four frame members, the four frame members comprising a first pair of parallel frame members and a second pair of parallel frame members, the first pair of parallel frame members being approximately perpendicular to the second pair of parallel frame members.

It is yet another aspect of the present invention to provide a massaging device in accordance with one or more aspects of the present invention described herein, further comprising a plurality of shafts extending in parallel and spaced apart relationship between the first pair of parallel frame members, wherein the plurality of shafts rotationally support the plurality of massaging elements.

It is yet another aspect of the present invention to provide a massaging device in accordance with one or more aspects of the present invention described herein, wherein each of the four frame members has a first side that in use is located proximate the animal's body, wherein the first side of each of the four frame members collectively form a first side of the frame, and wherein the massaging device further comprises a cushioning material provided along the first side of the frame to reduce discomfort to the animal when the frame is pressed against the animal's body.

It is yet another aspect of the present invention to provide a massaging device in accordance with one or more aspects of the present invention described herein, wherein each of the four frame members has a second side that in use is located away from the animal's body, wherein the second side of each of the four frame members collectively form a second side of the frame, and wherein the massaging device further comprises a friction material provided along the second side of the frame to resist the frame sliding relative to a stationary surface when the animal presses the frame member against the stationary surface with the frame positioned intermediate the animal's body and the stationary surface such that the animal can move its body relative to the frame by moving its body relative to the stationary surface to thereby receive the massage.

It is yet another aspect of the present invention to provide a massaging device in accordance with one or more aspects of the present invention described herein, wherein the cushioning material and the friction material are both the same padding material.

It is yet another aspect of the present invention to provide a massaging device in accordance with one or more aspects of the present invention described herein, wherein each of the rollers has a cylindrical surface and is provided with a plurality of protuberances on the cylindrical surface thereof.

It is yet another aspect of the present invention to provide a massaging device in accordance with one or more aspects of the present invention described herein, wherein the strap system comprises:

at least four strap portions extending from the frame, each of the strap portions having an end portion and a hook-and-loop fastener portion provided on the end portion thereof, the hook-and-loop fastener portion being selected from a strip of hook material and a strip of loop material.

It is yet another aspect of the present invention to provide a massaging device in accordance with one or more aspects of the present invention described herein, wherein the strap system further comprises:

a jacket that is configured for being placed on the animal's body so as to at least cover the animal's stomach, back, and sides, the material of the jacket being selected such that the hook-and-loop fastener portions at the end portions of the strap portions are capable of being securely fastened to the surface of the jacket, and when the jacket is placed on the animal, the frame is capable of being attached to the jacket over the stomach, back, or side of the animal to provide a massage to the animal.

It is yet another aspect of the present invention to provide a massaging device in accordance with one or more aspects of the present invention described herein, wherein the jacket is optional and may be replaced in the strap system by lengthening the four strap portions extending from the frame such that the front pair of strap portions can be placed around the animal's body and their ends secured together, and the rear pair of strap portions can be placed around the animal's body and their ends secured together, in order to hold the massaging device on the animal's body. Alternatively, the jacket can be replaced by a variety of other strap systems that are configured for secure placement on the animal's body and to provide attachment points for the four strap portions extending from the frame.

It is yet another aspect of the present invention to provide a massaging device in accordance with one or more aspects of the present invention described herein, wherein the massaging elements project outward beyond the first side of the frame so as to make contact with the animal's body in order to provide the massage to the animal.

It is yet another aspect of the present invention to provide a massaging device in accordance with one or more aspects of the present invention described herein, wherein the cylindrical surfaces of the rollers project outward beyond the first side of the frame.

It is yet another aspect of the present invention to provide a massaging device in accordance with one or more aspects of the present invention described herein, wherein the protuberances project outward beyond the first side of the frame so as to make contact with the animal's body in order to provide the massage to the animal.

It is yet another aspect of the present invention to provide a massaging device in accordance with one or more aspects of the present invention described herein, wherein the support structure is a frame supporting the massaging elements for rotational motion, and wherein the massaging elements are configured for rotational motion while administering the massage to the animal, wherein the frame has a first side that in use is located proximate the animal's body, wherein the frame has a second side that in use is located away from the animal's body, wherein the first side of the frame is open and the second side of the frame is closed.

It is yet another aspect of the present invention to provide a massaging device in accordance with one or more aspects of the present invention described herein, wherein the massaging device further comprises a cushioning material provided on the first side of the frame to reduce discomfort to the animal when the frame is pressed against the animal's body.

It is yet another aspect of the present invention to provide a massaging device in accordance with one or more aspects of the present invention described herein, wherein the massaging device further comprises a friction material provided on the second side of the frame to resist the frame sliding relative to a stationary surface when the animal presses the frame member against the stationary surface with the frame positioned intermediate the animal's body and the stationary surface such that the animal can move its body relative to the frame by moving its body relative to the stationary surface to thereby receive the massage.

These and other aspects and advantages of the present invention will be further elucidated by the following Detailed Description, drawing figures, and Claims.

### BRIEF DESCRIPTION OF THE DRAWINGS

FIG. 1 is a side view of the present invention on an example animal's (medium sized dog) stomach.

FIG. 2 is a side view of the present invention on an example animal's (medium sized dog) back.

FIG. 3 is a more detailed side perspective view of the invention.

FIG. 4 is a more detailed top perspective of the invention showing the open top side, which would be in contact with the animal's stomach or back general area.

FIG. 5 is a more detailed bottom perspective of the invention showing the closed bottom side, which is configured for being placed in contact with a surface such as the ground or a wall.

### DETAILED DESCRIPTION

This invention relates to domesticated and non-domesticated animal care and comfort. Specifically, this invention is a self-massager for animals. Non-domesticated animals may include animals kept in a stable or zoo.

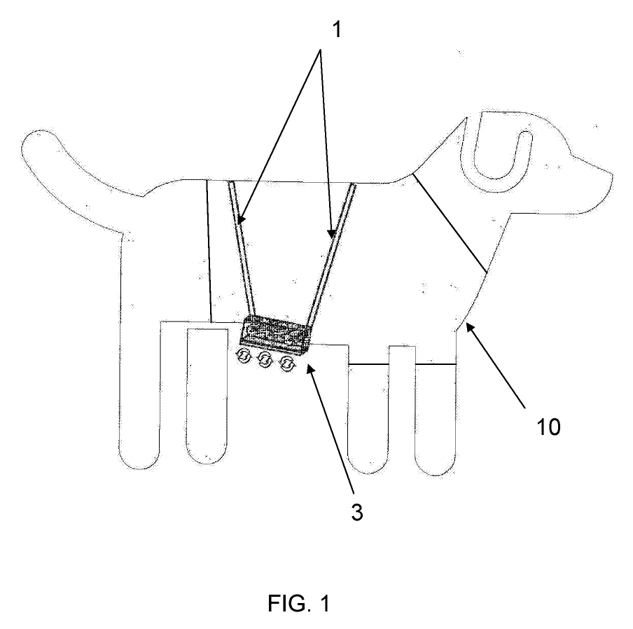

Referring to FIGS. 1-5, the invention has rotating rollers 7 with protuberances 7a that massage the animal's stomach or back general area using the animal's own applied force. The protuberances 7a in the illustrated embodiment are in the form of alternating elevated disks, preferably with rounded edges. The protuberances 7a may also be spherical, ellipsoidal, cylindrical, diamond, or other shapes. Also, there is padding 6a on the open top edge 6 of the box or frame 3 and padding 5a on the closed bottom side 5 of the box or frame 3 to provide additional comfort and prevent the box 3 from sliding when the animal applies its force to the box. The pad 5a on the bottom side of the box 3 prevents the box from sliding against surfaces such as the ground or a wall. Also, the padding 5a and 6a absorb some of the animal's force applied to the box to provide greater comfort and reduce the risk of injury.

The presence of the strap system allows the invention to be used on small, medium, and large domestic and non-domestic animals. In addition, the strap system allows the animal to easily walk around with the massaging device still attached.

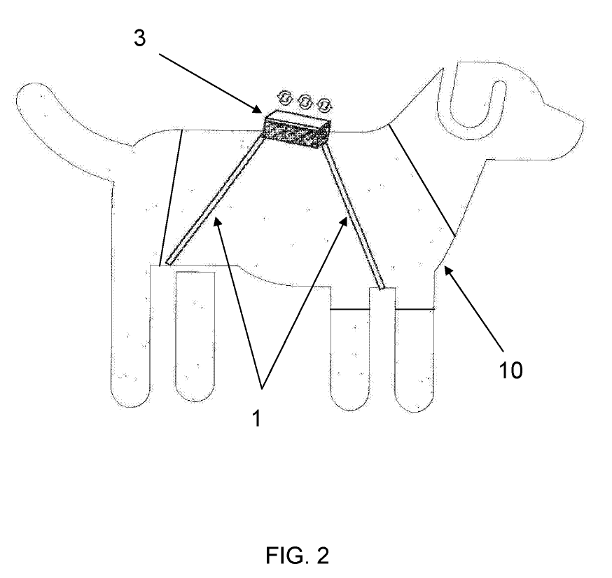

The descriptions made herein are intended for illustration purposes and do not act as a limitation on the claimed invention. Several embodiments of the strap system are contemplated. In the embodiments of FIGS. 1-5, the strap system includes at least four strap portions 1 extending from the corners of the frame or box 3. Each of the strap portions 1 has an end portion and a hook-and-loop fastener portion 2 provided on the end portion thereof. The hook-and-loop fastener portion 2 is selected from a strip of hook material and a strip of loop material. FIGS. 1 and 2 show an animal jacket 10 on a medium sized animal that is also part of the illustrated embodiment of the strap system. The material of the jacket 10 is selected such that the hook-and-loop fastener portion 2 is capable of being securely fastened to the surface of the jacket 10. When the jacket 10 is placed on the animal, the box or frame 3 can be attached to the jacket 10 over the stomach, back, or side of the animal to provide a massage to the animal. The strap portions 1 are preferably attached to the jacket 10 with sufficient slack in them to allow the desired amount of relative movement between the frame or box 3 and the animal's body to enhance the massaging action.

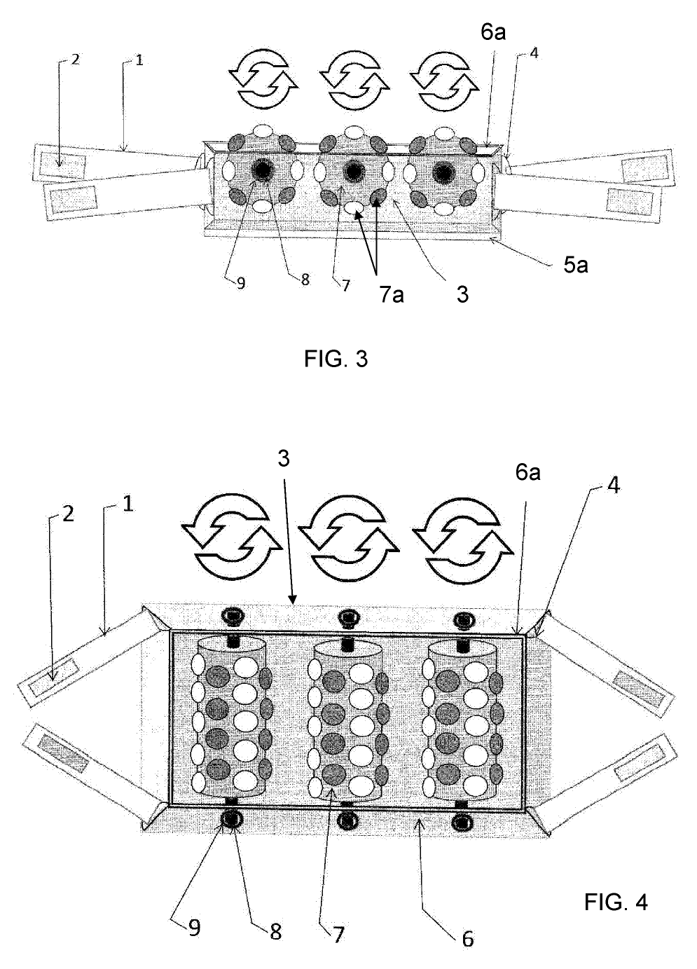

FIGS. 3-5 are diagrammatic views of the invention showing the elements discussed. The massaging device includes strap portions 1 that allow the massage device to be attached over the animal's back or stomach; means to attach the strap portions 1, such as hook-and-loop fastener portions or strips 2 (commonly referred to as VELCRO®), to the rest of the strap system; padding 6a on the exposed or open top edge 6 of the box 3; D-rings 4 for attaching the strap portions 1 to the frame or box 3; padding 5a on the bottom side 5 of the box 3; the box or frame 3 itself that is enclosed on all sides except for the top 6; the rotating or rotatable rollers 7 that administer the massage to the animal; the rods or shafts 8 that rotationally support the rollers 7 on or in the box or frame 3; and the bearings 9 that allow the rollers 7 and rods 8 to smoothly rotate without generating excessive friction.

The padding in FIG. 3 provides additional comfort and prevents the box from sliding when the animal applies its force to the box. The pad 5a on the bottom side of the box 3 prevents the box from sliding against surfaces such as the ground and wall. Also, the padding 5a and 6a absorb some of the animal's force applied to the box 3. The alternating elevated disks 7a massage the animal's stomach or back or other general area using the animal's own applied force.

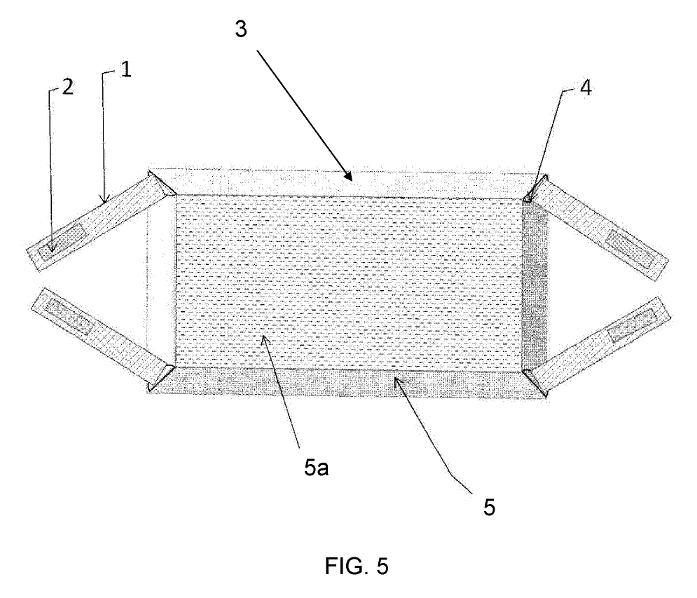

FIG. 5 is a diagrammatic bottom view of the invention showing the closed bottom of the box 3. The elements including the strap portions 1 for holding the box or frame 3 over the animal's back, stomach, or side; means to attach the strap portions 1, such as hook or loop strips 2; the D-rings 4 for attaching the strap portions 1 to the frame or box 3; the padding 5a on bottom 5 of the box or frame 3; and the box or frame 3 itself that is enclosed on all sides except for the top 6, can also be seen in this figure.

The animal would generate the force for the massage from its side to side or back and forth motion depending upon the mounting orientation of the box or frame 3. The straps 1 and hook or loop fastener strips 2 provide an anchor to keep the massager device in place. In the top side 6 that has an opening with the rollers 7 exposed, there are pads 6a added around the edges, which would be made of rubber or another cushioning or padding type material. There is another pad 5a on the bottom of the massage device that would contact the floor or a wall, which would be made of rubber or another cushioning or padding type material that also provides sufficient friction against stationary surfaces such as the floor or a wall such that, when the animal presses the frame 3 against the stationary surface, with the frame 3 positioned intermediate the animal's body and the stationary surface, the animal can move its body relative to the frame 3 by moving its body relative to the stationary surface to thereby receive a massage.

Alternative strap systems, may include a plurality of straps or a harness in place of the jacket 10. For example, the strap system may include a first strap and a second strap in place of the Jacket 10. Each of the first strap and the second strap would have two end portions and hook-and-loop fastener portions provided on the end portions thereof, the hook-and-loop fastener portions each being selected from a strip of hook material and a strip of loop material such that the end portions of the first strap are configured to be fastened to the end portions of a corresponding pair of the strap portions extending from the frame 3 with the first strap extending over the animal's body on a side of the animal's body that is opposite a side of the animal's body at which the frame 3 is located, The end portions of the second strap are configured to be fastened to the end portions of the other pair of the strap portions extending from the frame 3 with the second strap extending over the animal's body on a side of the animal's body that is opposite the side of the animal's body at which the frame 3 is located.

As yet another alternative, each pair of strap portions 1 may be the end portions of a single strap that extends through a sleeve provided on a side of the frame 3. This arrangement allows the four strap portions 1 to be provided by two straps and allows the frame 3 to slide along these two straps to provide for the relative movement between the animal's body and the frame 3 that is desirable for the massaging action.

As yet another alternative, the jacket 10 can be replaced by harness made of a plurality of straps. An exemplary harness may include a belly strap that goes around and under the animal's chest just behind the front legs and a shoulder strap that goes over the animal's shoulders. The ends of the belly strap are connected to the ends of the shoulder strap at a point preferably just behind and above the animal's shoulders. A chest strap goes around the front of the animal's chest ahead of the front legs. The ends of the chest strap are connected to the ends of the belly strap and/or the ends of the shoulder strap. A rear strap surrounds the animal's body ahead of the animal's hind quarters and some distance toward the rear of the animal from the shoulder and belly straps. Optional side straps extending along the sides of the animal's body may connect the ends of the belly strap and/or the ends of the shoulder strap to the rear strap on either side of the rear strap. An optional sternum strap may be connected between the middle of the chest strap and the middle of the belly strap, passing between the front legs, to prevent the chest strap from being positioned so high that it would interfere with the animal's breathing, especially when the harness is used for the attachment of a leash or reins.

The belly strap, the shoulder strap, the rear strap, and/or the side straps may be provided with strips of hook-and-loop fastener portions at a plurality of locations to allow the strap portions 1 to be attached to the harness and maintain the massager assembly, which includes the support frame 3 and the rotary massaging elements 7, over the animal's belly, back, or side as desired and in the orientation desired, in other words with the longitudinal axes of the shafts 8 or the rotational axes of the rollers 7 parallel to or perpendicular to the sagittal plane of the animal's body.

As yet another alternative, additional strips of hook-and-loop fastener portions may be provided along the length of the strap portions 1 to allow each of the strap portions 1 to be looped around the belly strap, the shoulder strap, the rear strap, and/or the side straps and then attached onto itself in order to attach the massager assembly to the harness.

The invention is not limited to the exemplary embodiments described above, but includes any and all embodiments within the scope of the appended claims both literally and under the doctrine of equivalents.

1. A massaging device for an animal, the animal having a body, the massaging device comprising:
a support structure;
a strap system for holding said support structure about the body of the animal; and
a plurality of massaging elements supported by said support structure,
wherein said strap system is configured to allow said support structure to assume a position in close enough proximity to the body of the animal such that motion of said massaging elements administers a massage to the animal or provides a massaging action to the animal.

2. The massaging device of claim 1, wherein said support structure is a frame supporting said massaging elements for rotational motion, and wherein said massaging elements are configured for rotational motion while administering the massage to the animal.

3. The massaging device of claim 2, wherein the massaging elements are rollers supported for rotational motion relative to said frame.

4. The massaging device of claim 2, wherein said frame is a rectangular frame including at least four frame members, said four frame members comprising a first pair of parallel frame members and a second pair of parallel frame members, said first pair of parallel frame members being approximately perpendicular to said second pair of parallel frame members.

5. The massaging device of claim 4, further comprising a plurality of shafts extending in parallel and spaced apart relationship between said first pair of parallel frame members, wherein said plurality of shafts rotationally support said plurality of massaging elements.

6. The massaging device of claim 5, wherein each of said four frame members has a first side that in use is located proximate the animal's body, wherein said first side of each of said four frame members collectively form a first side of said frame, and wherein the massaging device further comprises a cushioning material provided along said first side of said frame to reduce discomfort to the animal when said frame is pressed against the animal's body.

7. The massaging device of claim 6, wherein each of said four frame members has a second side that in use is located away from the animal's body, wherein said second side of each of said four frame members collectively form a second side of said frame, and wherein the massaging device further comprises a friction material provided along said second side of said frame to resist said frame sliding relative to a stationary surface when the animal presses the frame member against the stationary surface with said frame positioned intermediate the animal's body and the stationary surface such that the animal can move its body relative to said frame by moving its body relative to the stationary surface to thereby receive the massage.

8. The massaging device of claim 7, wherein said cushioning material and said friction material are both made of the same padding material.

9. The massaging device of claim 8, wherein each of said rollers has a cylindrical surface and is provided with a plurality of protuberances on said cylindrical surface thereof.

10. The massaging device of claim 9, wherein said strap system comprises:
at least four strap portions extending from said frame, each of said strap portions having an end portion and a hook-and-loop fastener portion provided on said end portion thereof, said hook-and-loop fastener portion being selected from a strip of hook material and a strip of loop material.

11. The massaging device of claim 10, wherein said strap system further comprises:
a jacket that is configured for being placed on the animal's body so as to at least cover the animal's stomach, back, and sides, said jacket having an outer surface, said jacket being made of a material selected such that said hook-and-loop fastener portions at said end portions of said strap portions are capable of being securely fastened to said outer surface of said jacket, and when said jacket is placed on the animal, said frame is capable of being attached to said jacket over the stomach, back, or side of the animal to provide a massage to the animal.

12. The massaging device according to claim 11, wherein said massaging elements project outward beyond said first side of said frame so as to make contact with the animal's body in order to provide the massage to the animal.

13. The massaging device of claim 9, wherein said cylindrical surfaces of said rollers project outward beyond said first side of said frame.

14. The massaging device of claim 9, wherein said protuberances project outward beyond said first side of said frame so as to make contact with the animal's body in order to provide the massage to the animal.

15. The massaging device of claim 1, wherein said support structure is a frame supporting said massaging elements for rotational motion, and wherein said massaging elements are configured for rotational motion while administering the massage to the animal, wherein said frame has a first side that in use is located proximate the animal's body, wherein said frame has a second side that in use is located away from the animal's body, wherein said first side of said frame is open and said second side of said frame is closed.

16. The massaging device of claim 15, wherein the massaging device further comprises a cushioning material provided on said first side of said frame to reduce discomfort to the animal when said frame is pressed against the animal's body.

17. The massaging device of claim 15, wherein the massaging device further comprises a friction material provided on said second side of said frame to resist said frame sliding relative to a stationary surface when the animal presses the frame member against the stationary surface with said frame positioned intermediate the animal's body and the stationary surface such that the animal can move its body relative to said frame by moving its body relative to the stationary surface to thereby receive the massage.

18. The massaging device of claim 17, wherein said cushioning material and said friction material are both made of the same padding material.

19. The massaging device of claim 3, wherein each of said rollers has a cylindrical surface and is provided with a plurality of protuberances on said cylindrical surface thereof.

20. The massaging device of claim 1, wherein said strap system comprises:
at least four strap portions extending from said frame, each of said strap portions having an end portion and a hook-and-loop fastener portion provided on said end portion thereof, said hook-and-loop fastener portion being selected from a strip of hook material and a strip of loop material.
